(19) United States
(12) Patent Application Publication
(10) Pub. No.: US 2012/0054323 A1
(43) Pub. Date: Mar. 1, 2012

(54) REGULATING MEDIA QUALITY USING A SESSION BANDWIDTH LIMIT

(75) Inventors: Subramanian Chandrasekaran, Redmond, WA (US); Anthony Bryan Bell, Carnation, WA (US)

(73) Assignee: Microsoft Corporation, Redmond, WA (US)

(21) Appl. No.: 12/870,861

(22) Filed: Aug. 30, 2010

(51) Int. Cl. G06F 15/16

(52) U.S. Cl. 709/223

(57) ABSTRACT

A session bandwidth limit is specified that defines the maximum amount of bandwidth that can be allocated to a single audio or video session on a network link. Prior to establishing an audio or video session on the network link, the session bandwidth limit is consulted to determine if a requested amount of bandwidth for the session can be allocated. The session may be established if the requested amount of bandwidth does not exceed the session bandwidth limit.

### BACKGROUND

Large organizations may operate many different physical locations around a city, state, country, or even around the world. In order to provide data and voice connectivity between locations, a number of wide area network (“WAN”) links may be established. The WAN links can be utilized to support data communications between the locations, including audio and/or audio/video sessions made between client devices placed at the locations. For instance, voice over Internet protocol (“VoIP”) calls may be made between clients placed at various locations connected by one or more WAN links. Similarly, video calls might also be made between clients placed at locations connected by WAN links.

Because network capacity is expensive, each physical location in a large network might be provisioned with a minimally appropriate amount of network bandwidth to support data activities to and from the location. For instance, a remote office with only a few employees might be provisioned with a relatively low amount of data capacity while another office with more employees might be provisioned with greater capacity. It may be possible, therefore, for a small number of clients to consume all of the available bandwidth on a WAN link if even just a few very high quality audio or video sessions are established concurrently. This might reduce the number of clients that are able to establish an audio or video session across the WAN link. For instance, only a few sessions of high definition video might utilize all of the bandwidth available on a WAN link. As a result, it might not be possible for other clients to establish audio or video sessions.

It is with respect to these and other considerations that the disclosure made herein is presented.

### SUMMARY

Technologies are described herein for regulating media quality using a session bandwidth limit. Through the utilization of the technologies and concepts presented herein, a system administrator can provision a session bandwidth limit that defines the maximum amount of bandwidth that can be allocated to a single audio or video session on a network link. Prior to establishing an audio or video session on the network link, the session bandwidth limit is consulted to determine if a requested amount of bandwidth for the session can be allocated. Through the use of the session bandwidth limit in this manner, an administrator can control the quality of audio and video sessions on a network link, and thereby prevent a few audio or video sessions from consuming a large portion of the bandwidth available on the link.

According to one aspect presented herein, a session bandwidth limit is defined and stored for a network link. As mentioned briefly above, the session bandwidth limit defines the maximum amount of bandwidth that can be allocated to a single session on the network link. A session may be an audio call, such as a VoIP call, or a video call (which might also include audio). An administrator might define the session bandwidth limit.

Prior to establishing an audio or video session, a bandwidth policy request is generated. The bandwidth policy request is a request for a specified amount of bandwidth for the session. The bandwidth policy request might describe a minimum amount of requested bandwidth and a maximum amount of requested bandwidth. The bandwidth policy request might also specify the network address for a calling client that initiated the session and the network address of the called client that is the destination for the session. The network addresses may be utilized to identify the particular network link that will be utilized for the session, the available bandwidth on the identified network link, and the session bandwidth limit for the identified network link. The bandwidth policy request may be made to a bandwidth policy service configured to receive and respond to bandwidth policy requests.

In response to receiving a bandwidth policy request, the session bandwidth limit is utilized to determine whether the session may be established. For instance, the requested amount of bandwidth may be compared to the session bandwidth limit for the network link. The session may be established if the requested amount of bandwidth is less than the session bandwidth limit. If the requested amount is greater than the session bandwidth limit, the session may be established using an amount of bandwidth equal to or less than the session bandwidth limit. According to other aspects, an additional determination may be made to ensure that the requested amount of bandwidth does not exceed an available amount of bandwidth for the relevant network link.

Once a determination has been made as to whether the session can be established in view of the session bandwidth limit and the available bandwidth for a network link, a response may be returned in response to the bandwidth policy request that indicates whether the session may be established. The response might also specify an amount of bandwidth, between the minimum and maximum amount requested, that can be allocated for the session. The session might then be established if the request is granted or cancelled if the request is denied.

This Summary is provided to introduce a selection of concepts in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a network diagram showing an illustrative operating environment along with several components provided according to embodiments presented herein;

FIGS. 2A-2C are data structure diagrams showing aspects of data structures for storing WAN link capacity data, WAN link utilization data, and a session bandwidth limit according to one embodiment disclosed herein;

FIG. 3 shows several flow diagrams that illustrate aspects of the operation of a calling client, a called client, and a bandwidth policy service according to one embodiment disclosed herein;

FIG. 4 is a flow diagram showing additional aspects of the operation of a bandwidth policy service according to one embodiment presented herein; and

FIG. 5 is a computer architecture diagram showing an illustrative computer hardware and software architecture for a computing system capable of implementing the embodiments presented herein.

### DETAILED DESCRIPTION

The following detailed description is directed to technologies for regulating media quality utilizing a session bandwidth limit. As discussed briefly above, a system administrator can provision a session bandwidth limit that defines the maximum amount of bandwidth that can be allocated to a single audio or video session on a network link Prior to establishing an audio or video session on the network link, the session bandwidth limit is consulted to determine if a requested amount of bandwidth for the session can be allocated. The session may be established if the session bandwidth limit is greater than the requested minimum amount of bandwidth.

While the subject matter described herein is presented in the general context of program modules that execute in conjunction with the execution of an operating system and application programs on a computer system, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

In the following detailed description, references are made to the accompanying drawings that form a part hereof, and which are shown by way of illustration specific embodiments or examples. Referring now to the drawings, in which like numerals represent like elements through the several figures, aspects of a computing system and methodology for regulating media quality using a session bandwidth limit will be described. It should be appreciated that although the embodiments disclosed herein have been presented in the context of audio and video calls, the mechanisms presented herein may be utilized to manage other types of streams. For instances, the embodiments disclosed herein may be utilized to manage data streams generated by application sharing programs, file sharing programs, and other types of data streams.

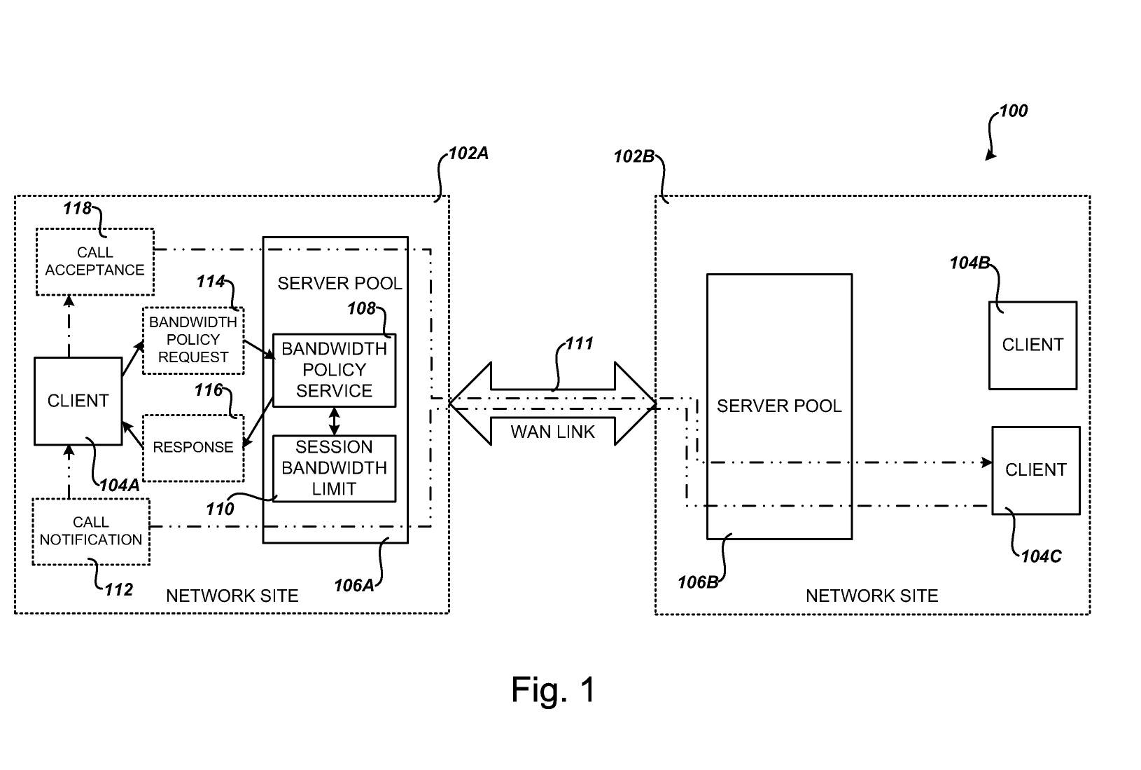

Turning now to FIG. 1, details will be provided regarding one embodiment presented herein for regulating media quality using a session bandwidth limit. In particular, FIG. 1 is a network diagram showing an illustrative operating environment along with several components provided according to embodiments presented herein. As shown in FIG. 1, the environment 100 includes a network site 102A configured for communication with a network site 102B by way of a WAN link 111. As discussed briefly above, the network sites 102A-102B may be located in different physical locations around a city, state, country, or even around the world.

In order to provide data and voice connectivity between the network sites 102A-102B, a WAN link 111 has been established between the two locations. The WAN link 111 can be utilized to support data communications between the network sites 102A-102B, including audio and/or audio/video sessions made between client devices situated at the network sites 102A-102B. For instance, VoIP calls may be made between clients located at the network sites 102A-102B. Similarly, video calls might also be made between clients placed at the network sites 102A-102B. Additional details regarding this process will be provided below. It should be appreciate that the term “call” and “session” may be used interchangeably herein.

As shown in FIG. 1, the network sites 102A-102B include a number of clients 104A-104C. For instance, the network site 102B includes the clients 104B-104C and the network site 102A includes the client 104A. The clients 104A-104C are devices that are capable of establishing an audio or video communications session with another client via a network link. For instance, in various embodiments, the clients 104A-104C may be wired or wireless telephones configured for communication over a data communications connection, desktop, laptop, or other types of computers configured with an appropriate software client for audio and/or video communications over a data communications link, and other types of devices. It should be appreciated that while FIG. 1 illustrates two network sites 102A-102B and three clients 104A-104C, many more network sites and clients may be utilized. It should also be appreciated that the environment 100 has been shown in a simplified form and that many more network connections and computing systems may be required in order to utilize the various concepts disclosed herein.

As also shown in FIG. 1, each of the network sites includes a server pool 106. For instance, the network site 102A has a server pool 106A and the network site 102B includes a server pool 106B. The server pools 106A-106B are installations of one or more server computers configured to provide services to the clients 104A-104C. For instance, according to various embodiments, the server pools 106A-106B may assist the clients 104A-104C during call setup and establishment, name resolution, media conversion, and in other ways. In order to provide this functionality, the servers operating within the server pools 106A-106B may be configured to expose a number of services to the clients 104A-104C.

One service offered by the server pools 106A-106B is a bandwidth policy service 108. The bandwidth policy service 108 is an executable component executed by one or more of the server computers of the server pools 106A-106B. As will be discussed in greater detail herein, the bandwidth policy service 108 is configured to receive and respond to bandwidth policy requests, such as the bandwidth policy request 114 illustrated in FIG. 1.

In order to respond to a bandwidth policy request 114, the bandwidth policy service 108 may store and utilize a session bandwidth limit 110. As discussed briefly above, the session bandwidth limit 110 defines the maximum amount of bandwidth that can be allocated to a single session on a network link, such as the WAN link 111. As will be discussed in greater detail below, the session bandwidth limit 110 may specify the maximum bandwidth that can be allocated to an audio call and a maximum amount of bandwidth that can be allocated to a video call on a particular network link, such as the WAN 111. The session bandwidth limit 110 may be specified by an administrator of the server pool 106A. Additional details regarding the operation of the bandwidth policy service 108 and the utilization of the session bandwidth limit 110 will be provided below

FIG. 1 also illustrates aspects of the establishment of a voice or video call between a client 104C (which may be referred to herein as a “calling client”) located at the network site 102B and the client 104A (which may be referred to herein as a “called client”) located at the network site 102A. In particular, when a user of the client 104C initiates an audio or video call to the client 104A, the client 104C transmits a call notification 112 to the client 104A. In order to determine whether the call can be accepted, the client 104A transmits a bandwidth policy request 114 to the bandwidth policy service 108 prior to accepting the call.

The bandwidth policy request 114 is a request to the bandwidth policy service 108 for authorization to establish a session with the client 104C. According to one implementation, the bandwidth policy request 114 includes a minimum amount of bandwidth requested and a maximum amount of bandwidth requested for the new session. The bandwidth policy request 114 might also include the network address of the client 104A and the network address of the client 104C.

In response to receiving the bandwidth policy request 114, the bandwidth policy service 108 determines whether the request may be satisfied and the call between the client 104A and the client 104C may be established. In particular, the bandwidth policy service 108 may first utilize the network addresses provided in the bandwidth policy request 114 to identify the particular WAN link 111 that will be utilized for the new session. For instance, the bandwidth policy service 108 may use the network addresses to identify a subnet. From the subnet, the bandwidth policy service 108 can identify the physical location of the clients. Once the physical location has been identified, the bandwidth policy service 108 can determine the particular WAN link 111 to be utilized. Once the WAN link 111 has been identified, the bandwidth policy service 108 can identify the session bandwidth limit 110 that applies to the WAN link 111.

Utilizing the network addresses of the client 104A and the client 104C, the bandwidth policy service 108 can also determine the available amount of bandwidth on the WAN link 111. Accordingly, once the session bandwidth limit 110 for the WAN link 111 and the available amount of bandwidth on the WAN link 111 have been determined, the bandwidth policy service 108 can evaluate the bandwidth policy request 114. According to one implementation, the bandwidth policy service 108 evaluates the bandwidth policy request 114 by comparing the requested amount of bandwidth to the session bandwidth limit 110. If the requested amount of bandwidth is less than the session bandwidth limit 110 and the requested amount of bandwidth is available on the appropriate network link, then the requested amount of bandwidth can be granted. If the requested amount of bandwidth is greater than the session bandwidth limit 110 and that amount of bandwidth is available on the network link, then an amount of bandwidth is granted that is equal to the session bandwidth limit 110.

According to other aspects, the bandwidth policy service might also compare the amount of requested bandwidth to the available bandwidth on the WAN link 111. If the requested amount of bandwidth exceeds the available amount of bandwidth on the WAN link 111, the bandwidth policy request 114 might also be denied. If the requested amount of bandwidth is less than the session bandwidth limit 110 and less than the available bandwidth on the WAN link 111, the bandwidth policy service 108 may grant the bandwidth policy request 114.

Once the bandwidth policy service 108 has evaluated the bandwidth policy request 114, the bandwidth policy service 108 may transmit a response 116 to the client 104A. The response 116 may indicate whether the request 114 was granted or denied. The response 116 might also specify a particular amount of bandwidth to be utilized by the client 104A in setting up a session with the client 104C. For instance, the response 116 might indicate an amount of bandwidth to be utilized by the client 104 that is between the minimum amount requested and the maximum amount requested in the bandwidth policy request 114.

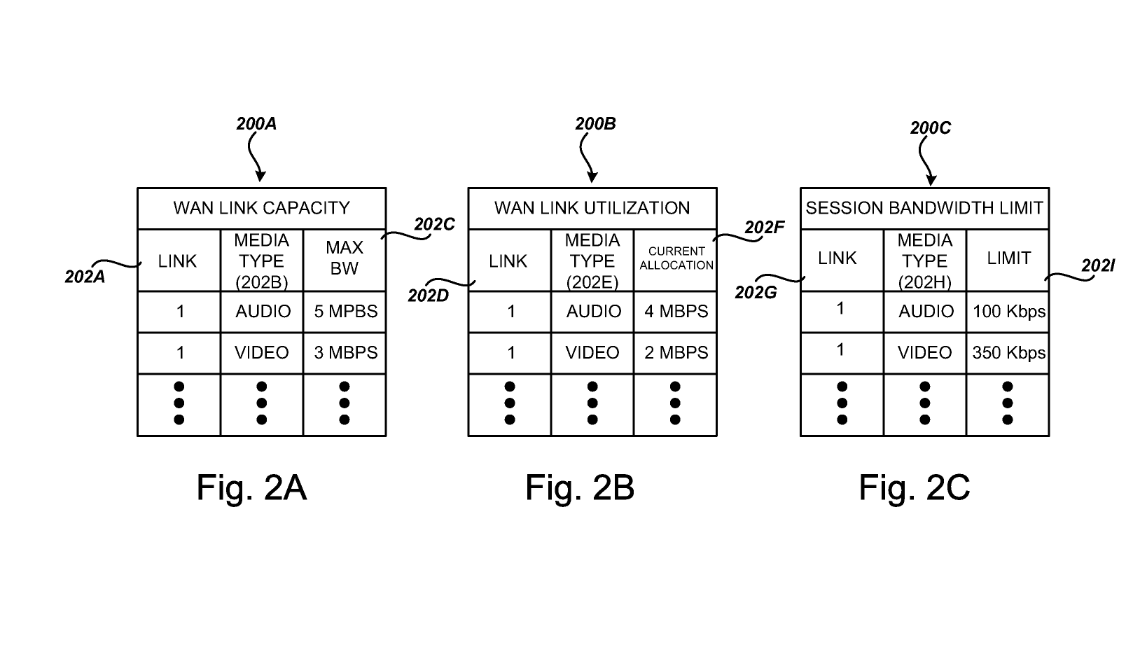

If the bandwidth policy service 108 indicates in the response 116 that the requested amount of bandwidth has been granted, the client 104A will transmit a call acceptance 118 to the client 104C. Thereafter, the clients 104A and 104C will begin transmitting media over the WAN link 111. For instance, if the session established between the client 104A and the client 104C is a voice session, the clients 104A and 104C will transmit appropriate audio data across the WAN link 111. The session between the client 104A and the client 104C may then continue and be terminated in a traditional fashion. Additional details regarding the operation of the bandwidth policy service 108 will be provided below with respect to the FIGS. 2A-5.

FIGS. 2A-2C are data structure diagrams showing aspects of several data structures for storing WAN link capacity data, WAN link utilization data, and a session bandwidth limit according to one embodiment disclosed herein. As discussed briefly above, while the embodiments disclosed herein have been presented mainly in the context of audio and video calls, the mechanisms presented herein may be utilized to manage other types of streams. For instances, the embodiments disclosed herein may be utilized to manage data streams generated by application sharing programs, file sharing programs, and other types of data streams. Accordingly, it should be appreciated that the data structures shown in FIGS. 2A-2C are merely illustrative and that other data structures may be used to store other data.

FIG. 2A shows a data structure 200A configured for storing data indicating WAN link capacity. As discussed briefly above, the bandwidth policy service 108 might utilize information regarding the capacity and utilization of a WAN link to determine whether a bandwidth policy request may be granted. In the illustrative embodiment shown in FIG. 2A, the data structure 200A includes a first field 202A that identifies the WAN link 111. The data structure 200A also includes a field 202B that identifies a particular media type, such as audio or video. The data structure 200A also includes a field 202C that identifies the maximum bandwidth for a particular link and media type. For instance, in the example shown in FIG. 2A, data has been provided for a WAN link 111 capable of supporting five mega-bits per second (“Mbps”) of audio and three Mbps of video. It should be appreciated that the data structures shown in FIGS. 2A-2B are configured by an administrator in one embodiment and are generally static. The data structure shown in FIG. 2C is dynamic and is updated periodically by the bandwidth policy service 108. In one embodiment, the data structure 200C is updated in near real-time.

FIG. 2B shows a data structure 200B utilized to maintain data indicating a current utilization of a WAN link 111. The data stored in the data structure 200B might also be utilized by the bandwidth policy service 108 to determine whether a particular bandwidth policy request 114 may be granted. The contents of the data structure 200B may be updated in real or near real-time according to various embodiments.

The illustrative data structure 200B shown in FIG. 2B includes a field 202D for storing data identifying the particular WAN link 111, a field 202E for storing data identifying a particular media type, and a field 202F for storing identifying a current allocation of bandwidth for the link and media type. For instance, in the example shown in FIG. 2B, the data structure 200B includes data indicating that the WAN link 111 currently has four Mbps of audio and two Mbps of video allocated thereto. Accordingly, in view of the example data structures 200A and 200B, the bandwidth policy service 108 may conclude that the WAN link 111 has one Mbps available for audio and one Mbps available for video sessions. It should be appreciated that the data structures 200A and 200B are merely illustrative and have been simplified for the purposes of discussion presented herein. Accordingly, the bandwidth policy service 108 might store other data or might store the data shown in FIGS. 2A and 2B in a different form.

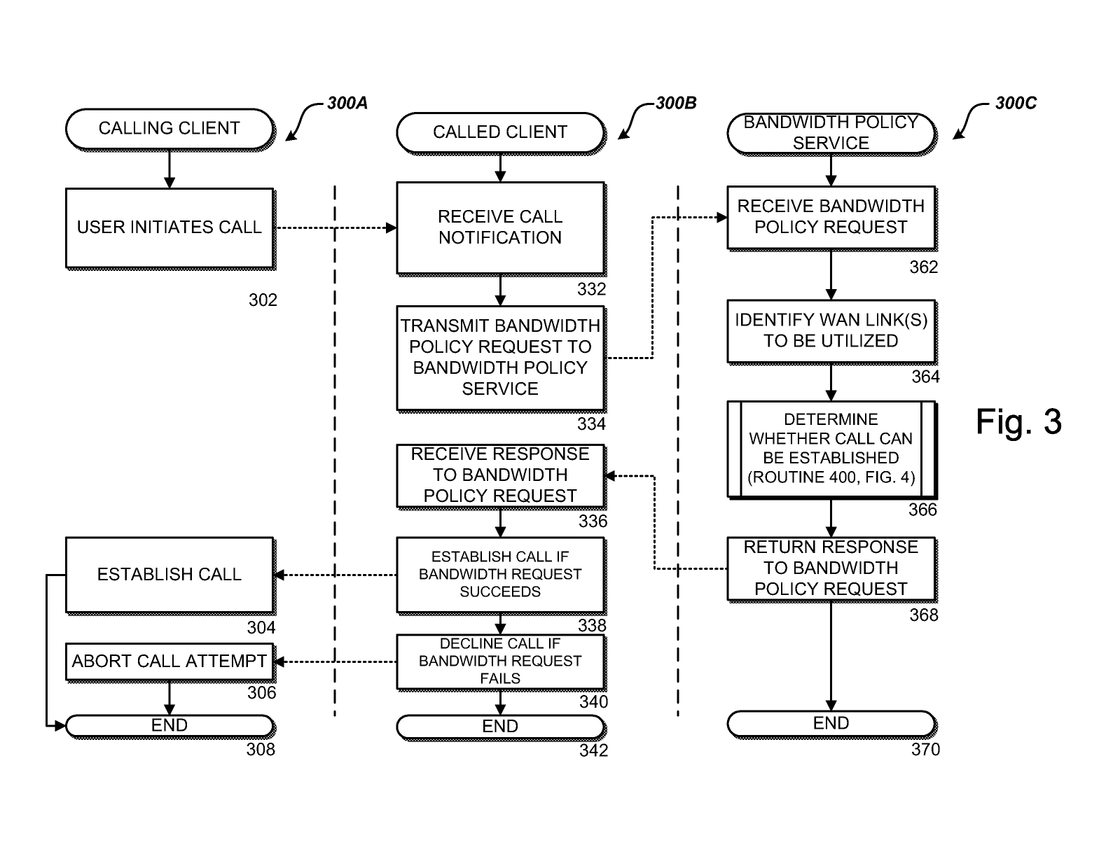

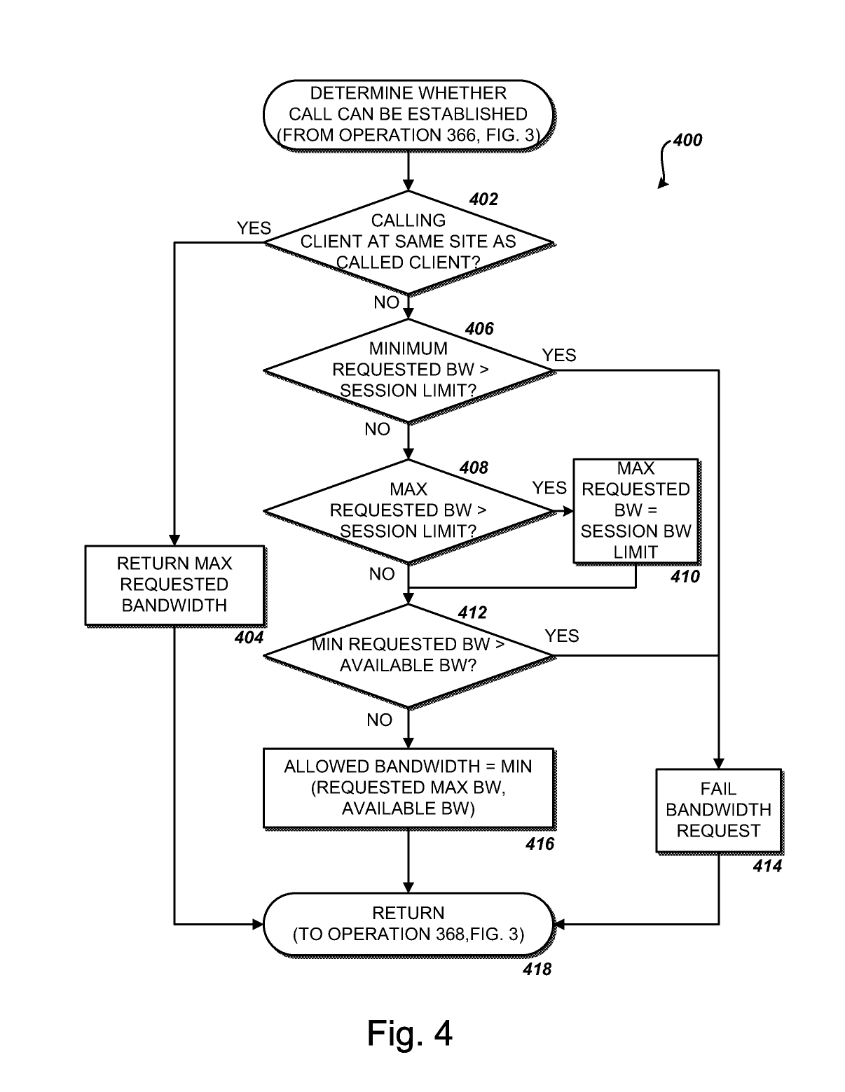

FIG. 2C shows an illustrative data structure 200C that may be utilized to store the session bandwidth limit 110. In the illustrative example shown in FIG. 2C, the data structure 200C includes a field 202G for storing data identifying a particular network link 111, a field 202H for storing data identifying a media type, and a field 202I for storing the session bandwidth limit 110 for the particular link and media type. In the example shown in FIG. 2C, a session bandwidth limit of 100 kilobits second (“kbps”) has been defined for audio calls on the WAN link 111. Additionally, a session bandwidth limit 110 of 350 kbps has been allocated for video calls on the WAN link 111. It should be appreciated that the data structure 200C has also been simplified and that other data might also be stored in the data structure 200C for use by the bandwidth policy service 108. Additional detail regarding the use of the data stored in the data structures 200A-200C by the bandwidth policy service 108 will be provided below with respect to FIGS. 3-4.

Turning now to FIG. 3, additional details will be provided regarding the embodiments presented herein for regulating media quality using a bandwidth policy service. In particular, FIG. 3 shows several routines 300A, 300B, and 300C that illustrate aspects of the operation of a calling client 104C, a called client 104A, and a bandwidth policy service 108, respectively, according to one embodiment disclosed herein.

It should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as operations, structural devices, acts, or modules. These operations, structural devices, acts and modules may be implemented in software, in firmware, in special purpose digital logic, and any combination thereof. It should also be appreciated that more or fewer operations may be performed than shown in the figures and described herein. These operations may also be performed in a different order than those described herein.

The routine 300A begins at operation 302, where a user initiates a call at the calling client 104C. In response to the initiation of the call, the called client 104A will receive a call notification 112 at operation 332. In response thereto, the called client 104A transmits a bandwidth policy request 114 to the bandwidth policy service 108 at operation 334. As discussed above, the bandwidth policy request might describe a minimum amount of requested bandwidth and a maximum amount of requested bandwidth.

The bandwidth policy service 108 receives the bandwidth policy request 114 at operation 362 of the routine 300C. The bandwidth policy service 108 then identifies the WAN link, or links, to be utilized for the new session at operation 364. As described above, the bandwidth policy service might utilize the network addresses of the calling client 104C and the called client 104A to determine that the WAN link 111 will be utilized for a session between the clients 104C and 104A. It should be appreciated that the bandwidth policy service 108 might maintain or access data defining a network topology in order to make this determination.

From operation 364, the routine 300C proceeds to operation 366. At operation 366, the bandwidth policy service 108 determines whether the new call can be established between the calling client 104C and the called client 104A. As described briefly above, the bandwidth policy service 108 might utilize the session bandwidth limit 110 and the available bandwidth on the WAN link 111 to make this determination. Additional details regarding one process performed by the bandwidth policy service 104 to determine whether a session can be established will be provided below with respect to FIG. 4. From operation 366, the routine 300C continues to operation 368 where the bandwidth policy service 108 returns the response 116 to the called client 104A in response to the bandwidth policy request 114. The routine 300C then proceeds to operation 370, where it ends.

The routine 300B continues at operation 336 where the called client 104A receives the response 116 to the bandwidth policy request 114. As described above, the response 116 may indicate whether the client 104A can accept the call request received from the calling client 104C. The response 116 might also indicate an amount of bandwidth that should be utilized to establish a new session. Accordingly, from operation 336, the routine 300B proceeds to operation 338 where the client 104A transmits a call acceptance 118 to the client 104C if the response 116 indicates an amount of bandwidth to be utilized for the call. If the response 116 indicates that the call may not be established (for instance, if there is not enough bandwidth available on the WAN link to support the call or the minimum amount of requested bandwidth is greater than the session bandwidth limit), the client 104A declines the call at operation 340 of the routine 300B. From operation 340, the routine 300B proceeds to operation 342, where it ends.

The routine 300A continues at operation 304 where the calling client 104C receives the call acceptance 118 and the call is established between the client 104A and the client 104C. As discussed above, the clients 104A and 104C will transmit media for the call over the WAN link 111. The call will proceed and be terminated in a traditional fashion. If, however, the response 116 indicates that the call may not be established, then the client 104C terminates the call at operation 306. According to one embodiment, the new call may be established over the Internet or the Public Switched Telephone Network (“PSTN”) if the call cannot be completed over the WAN link 111. From operations 304 and 306, the routine 300A proceeds to operation 308, where it ends.

FIG. 4 is a flow diagram showing a routine 400 that illustrates additional aspects of one methodology performed by the bandwidth policy service 108 to determine whether a session can be established. The routine 400 begins at operation 402, where the bandwidth policy service 108 determines whether the calling client 104C is at the same network site 102 as the called client 104A. The bandwidth policy service 108 might make this determination utilizing the network addresses of the calling client 104C and the called client 104A provided in the bandwidth policy request 114 in the manner described above. If the calling client 104C and the called client 104A are located at the same network site 102, the bandwidth policy service 108 concludes that the call may be established between the calling client 104C and the called client 104A without a bandwidth restriction. In this manner, the limitations on bandwidth utilization imposed by the session bandwidth limit 110 are avoided when a WAN link is not required for voice or data communication between two clients. In this case, the routine 400 proceeds from operation 400 to operation 404, where the maximum requested bandwidth is returned by the bandwidth policy service 108. The routine 400 then proceeds from operation 404 to operation 418.

If, at operation 402, the bandwidth policy service 108 determines that the calling client 104C and the called client 104A are not at the same network site 102, the routine 400 proceeds from operation 402 to operation 406. At operation 406, the bandwidth policy service 108 determines whether the minimum amount of bandwidth requested is greater than the session bandwidth limit 110. If so, the routine 400 proceeds to operation 414 where the bandwidth policy service 108 causes the bandwidth policy request 114 to be denied. If the minimum requested bandwidth is not less than the bandwidth session limit 110, then the routine 400 proceeds from operation 406 to operation 408.

At operation 408, the bandwidth policy service 108 determines whether the maximum requested bandwidth is greater than the session bandwidth limit 110. If so, the routine 400 proceeds from operation 408 to operation 410 where the maximum requested bandwidth is set equal to the session bandwidth limit 110. The routine 400 then proceeds from operation 410 to operation 412. If the maximum requested bandwidth is not greater than the session bandwidth limit 110 then the routine 400 proceeds directly from operation 408 to operation 412.

At operation 412, the bandwidth policy service 108 determines if the minimum requested bandwidth is greater than the bandwidth available on the WAN link 111. If so, the routine 400 proceeds from operation 412 to operation 414 where the bandwidth policy service 108 causes the bandwidth policy request 114 to be denied. If the minimum requested bandwidth is not greater than the bandwidth available on the WAN link 111, the routine 400 proceeds from operation 412 to operation 416. At operation 416, the bandwidth policy service 108 computes the bandwidth available for the new session as the minimum of the requested maximum bandwidth and the session bandwidth limit. From operations 414 and 416, the routine 400 proceeds to operation 412 where it returns to operation 368 in FIG. 3, described above.

It should be appreciated that the flow diagram illustrated in FIG. 4 shows one mechanism for determining whether a bandwidth policy request 114 may be granted. Other mechanisms might also be utilized. It should also be appreciated that, in the embodiments disclosed herein, the called client 104A transmits the bandwidth policy request 114 to the bandwidth policy service 108. In other embodiments, however, the calling client 104C may transmit the bandwidth policy request 114 to the bandwidth policy service 108 prior to or after the transmission of a call notification 112. Other implementations might also be utilized.

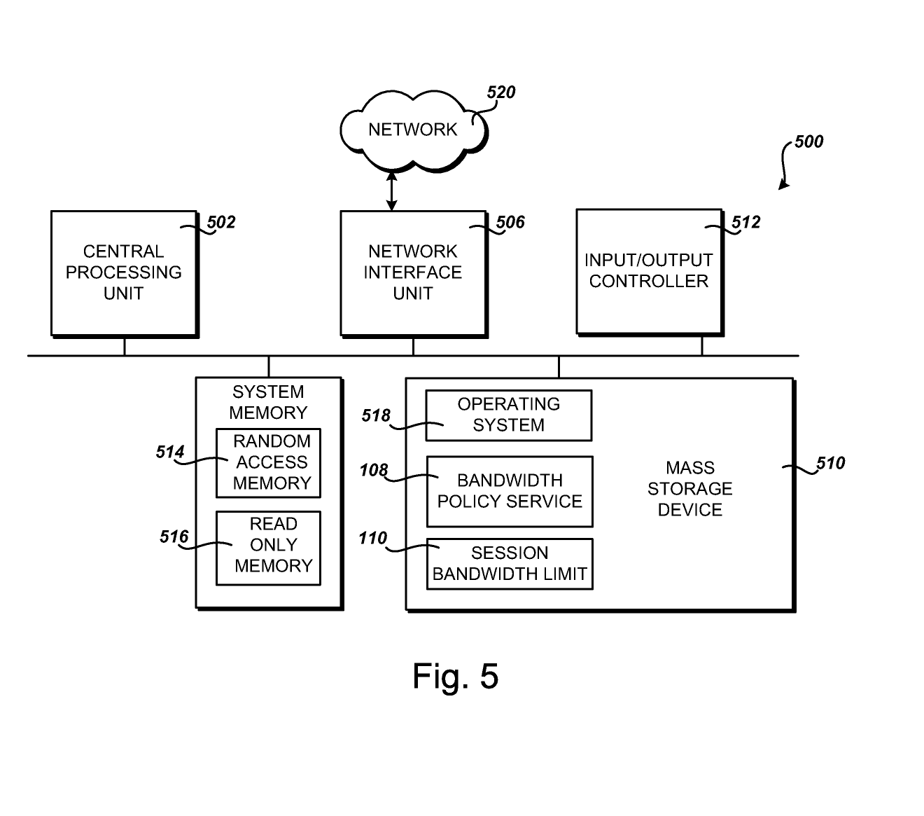

FIG. 5 shows an illustrative computer architecture for a computer 500 capable of executing the software components described herein for regulating media quality using a session bandwidth limit. The computer architecture shown in FIG. 5 illustrates a conventional desktop, laptop computer, or server computer and may be utilized to execute the various software components described herein.

The computer architecture shown in FIG. 5 includes a central processing unit 502 (“CPU”), a system memory 508, including a random access memory 514 (“RAM”) and a read-only memory (“ROM”) 516, and a system bus 504 that couples the memory to the CPU 502. A basic input/output system (“BIOS”) containing the basic routines that help to transfer information between elements within the computer 500, such as during startup, is stored in the ROM 516. The computer 500 further includes a mass storage device 510 for storing an operating system 518, application programs, and other program modules, which will be described in greater detail below.

The mass storage device 510 is connected to the CPU 502 through a mass storage controller (not shown) connected to the bus 504. The mass storage device 510 and its associated computer-readable media provide non-volatile storage for the computer 500. Although the description of computer-readable media contained herein refers to a mass storage device, such as a hard disk or CD-ROM drive, it should be appreciated by those skilled in the art that computer-readable storage media can be any available computer storage media that can be accessed by the computer 500.

By way of example, and not limitation, computer-readable storage media may include volatile and non-volatile, removable and non-removable media implemented in any method or technology for storage of information such as computer-readable instructions, data structures, program modules or other data. For example, computer-readable storage media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other non-transitory medium which can be used to store the desired information and which can be accessed by the computer 500.

According to various embodiments, the computer 500 may operate in a networked environment using logical connections to remote computers through a network such as the network 520. The computer 500 may connect to the network 520 through a network interface unit 506 connected to the bus 504. It should be appreciated that the network interface unit 506 may also be utilized to connect to other types of networks and remote computer systems. The computer 500 may also include an input/output controller 512 for receiving and processing input from a number of other devices, including a keyboard, mouse, or electronic stylus (not shown in FIG. 5). Similarly, an input/output controller may provide output to a display screen, a printer, or other type of output device (also not shown in FIG. 5).

As mentioned briefly above, a number of program modules and data files may be stored in the mass storage device 510 and RAM 514 of the computer 500, including an operating system 518 suitable for controlling the operation of a networked desktop, laptop, or server computer. The mass storage device 510 and RAM 514 may also store one or more program modules. In particular, the mass storage device 510 and the RAM 514 may store the bandwidth policy service 108, which has been described above. The mass storage device 510 and RAM 514 may also store other program modules and data, such as the session bandwidth limit 110.

In general, software applications or modules may, when loaded into the CPU 502 and executed, transform the CPU 502 and the overall computer 500 from a general-purpose computing system into a special-purpose computing system customized to perform the functionality presented herein. The CPU 502 may be constructed from any number of transistors or other discrete circuit elements, which may individually or collectively assume any number of states. More specifically, the CPU 502 may operate as one or more finite-state machines, in response to executable instructions contained within the software or modules. These computer-executable instructions may transform the CPU 502 by specifying how the CPU 502 transitions between states, thereby physically transforming the transistors or other discrete hardware elements constituting the CPU 502.

Encoding the software or modules onto a mass storage device may also transform the physical structure of the mass storage device or associated computer readable storage media. The specific transformation of physical structure may depend on various factors, in different implementations of this description. Examples of such factors may include, but are not limited to: the technology used to implement the computer readable storage media, whether the computer readable storage media are characterized as primary or secondary storage, and the like. For example, if the computer readable storage media is implemented as semiconductor-based memory, the software or modules may transform the physical state of the semiconductor memory, when the software is encoded therein. For example, the software may transform the states of transistors, capacitors, or other discrete circuit elements constituting the semiconductor memory.

As another example, the computer readable storage media may be implemented using magnetic or optical technology. In such implementations, the software or modules may transform the physical state of magnetic or optical media, when the software is encoded therein. These transformations may include altering the magnetic characteristics of particular locations within given magnetic media. These transformations may also include altering the physical features or characteristics of particular locations within given optical media, to change the optical characteristics of those locations. Other transformations of physical media are possible without departing from the scope and spirit of the present description, with the foregoing examples provided only to facilitate this discussion.

Based on the foregoing, it should be appreciated that technologies for regulating media quality using a session bandwidth limit have been presented herein. Although the subject matter presented herein has been described in language specific to computer structural features, methodological acts, and computer readable media, it is to be understood that the invention defined in the appended claims is not necessarily limited to the specific features, acts, or media described herein. Rather, the specific features, acts and mediums are disclosed as example forms of implementing the claims.

The subject matter described above is provided by way of illustration only and should not be construed as limiting. Various modifications and changes may be made to the subject matter described herein without following the example embodiments and applications illustrated and described, and without departing from the true spirit and scope of the present invention, which is set forth in the following claims.

What is claimed is:

1. A computer-implemented method for regulating media quality using a session bandwidth limit, the method comprising:
storing data defining a session bandwidth limit;
receiving a bandwidth policy request for a session;
in response to receiving the bandwidth policy request, utilizing the session bandwidth limit to determine whether the session may be established; and
returning a response in reply to the request indicating whether the session may be established.

2. The computer-implemented method of claim 1, wherein the session bandwidth limit comprises the maximum amount of bandwidth that can be allocated to a single session on a network link.

3. The computer-implemented method of claim 2, wherein a session comprises an audio call or a video call.

4. The computer-implemented method of claim 3, wherein the bandwidth policy request comprises a requested amount of bandwidth for the session.

5. The computer-implemented method of claim 4, wherein utilizing the session bandwidth limit to determine whether the session may be established comprises comparing the requested amount of bandwidth for the session to the session bandwidth limit, and determining that the session may be established if the requested amount of bandwidth is less than the session bandwidth limit.

6. The computer-implemented method of claim 5, further comprising determining that the session may be established with an amount of bandwidth equal to the session bandwidth limit if the requested amount of bandwidth is greater than the session bandwidth limit and a minimum amount of bandwidth requested is less than the session bandwidth limit.

7. The computer-implemented method of claim 6, wherein determining whether the session may be established further comprises comparing the requested amount of bandwidth to an available amount of bandwidth, and determining that the session may be established if the requested amount of bandwidth is less than the available amount of bandwidth.

8. The computer-implemented method of claim 7, further comprising determining that the session may not be established if the requested amount of bandwidth is greater than the available amount of bandwidth.

9. The computer-implemented method of claim 8, wherein the bandwidth policy request further specifies a network address for a calling client that initiated the session and a network address for a called client that is a destination for the session.

10. The computer-implemented method of claim 9, wherein the network address for the calling client and the network address for the called client are utilized in part to determine the available amount of bandwidth.

11. A computer-readable storage medium having computer-executable instructions stored thereupon which, when executed by a computer, cause the computer to:
receive a bandwidth policy request;
in response to receiving the bandwidth policy request, utilizing a session bandwidth limit to determine whether the session may be established; and
returning a response in reply to the request indicating whether the session may be established.

12. The computer-readable medium of claim 11, wherein the session bandwidth limit comprises the maximum amount of bandwidth that can be allocated to a single session on a network link.

13. The computer-readable medium of claim 12, wherein a session comprises an audio call or a video call.

14. The computer-readable medium of claim 13, wherein the bandwidth policy request comprises a requested amount of bandwidth for the session.

15. The computer-readable medium of claim 14, wherein utilizing the session bandwidth limit to determine whether the session may be established comprises comparing the requested amount of bandwidth for the session to the session bandwidth limit, and determining that the session may be established if the requested amount of bandwidth is less than the session bandwidth limit.

16. The computer-readable medium of claim 15, having further computer-executable instructions stored thereupon which, when executed by the computer, cause the computer to determine that the session may be established with an amount of bandwidth less than the requested amount of bandwidth if the requested amount of bandwidth is greater than the session bandwidth limit.

17. The computer-readable medium of claim 16, wherein determining whether the session may be established further comprises comparing the requested amount of bandwidth to an available amount of bandwidth, and determining that the session may be established if the requested amount of bandwidth is less than the available amount of bandwidth.

18. The computer-readable medium of claim 17, having further computer-executable instructions stored thereupon which, when executed by the computer, cause the computer to determine that the session may not be established if the requested amount of bandwidth is greater than the available amount of bandwidth.

19. The computer-readable medium of claim 18, wherein the bandwidth policy request further specifies a network address for a calling client that initiated the session and a network address for a called client that is a destination for the session, and wherein the network address for the calling client and the network address for the called client are utilized in part to determine the available amount of bandwidth.

20. A computer-implemented method for regulating media quality using a session bandwidth limit, the method comprising:
storing data defining a session bandwidth limit, the session bandwidth limit comprising the maximum amount of bandwidth that can be allocated to a single audio call or video call on a network link;
receiving a bandwidth policy request for a session, the bandwidth policy request comprising a requested amount of bandwidth for the session, a network address for a calling client that initiated the session, and a network address for a called client that is a destination for the session;
in response to receiving the bandwidth policy request, utilizing the session bandwidth limit to determine whether the session may be established by comparing the requested amount of bandwidth for the session to the session bandwidth limit, and determining that the session may be established if the requested amount of bandwidth is less than the session bandwidth limit; and
returning a response in reply to the request indicating whether the session may be established.
